(19) United States
(12) Patent Application Publication
(10) Pub. No.: US 2010/0202441 A1
(43) Pub. Date: Aug. 12, 2010

(54) METHOD AND APPARATUS FOR THE USER-SPECIFIC CONFIGURATION OF A COMMUNICATIONS PORT

(75) Inventors: Thomas Haag, Rodgau (DE); Michael Busser, Bad Kreuznach (DE); Bernd Kraus, Schaafheim (DE); Klaus Meyer, Bensheim (DE); Peter Hamacher, Rossdorf (DE)

Correspondence Address: LEYDIG, VOIT AND MAYER, TWO PRUDENTIAL PLAZA, SUITE 4900, 180 NORTH STETSON AVENUE, CHICAGO, IL, 60601, US

(73) Assignee: DEUTSCHE TELEKOM AG, Bonn (DE)

(21) Appl. No.: 12/602,749

(22) PCT Filed: May 27, 2008
(86) PCT No.: PCT/EP2008/004179

§ 371 Date: Dec. 2, 2009

(30) Foreign Application Priority Data
Aug. 21, 2007 (DE) 10 2007 039 516.9

(51) Int. Cl. H04L 12/66; H04J 3/16

(52) U.S. Cl. 370/352; 370/437

(57) ABSTRACT

A method and an apparatus for the user-specific configuration of a communications port includes provisioning a default profile that references a predetermined user, assigning the default profile to a user-specific configuration profile that is assigned to the predetermined user, and configuring the communications port using the user-specific configuration profile.

### CROSS REFERENCE TO RELATED APPLICATIONS

This application is a U.S. National Phase application under 35 U.S.C. §371 of International Application No. PCT/EP2008/004179, filed May 27, 2008, and claims benefit to German patent application DE 10 2007 039 516.9, filed Aug. 21, 2007. The international Application was published in German on Feb. 26, 2009 as WO 2009/024198 A1 under PCT Article 21 (2).

### FIELD

The present invention relates generally to the field of communications networks and specifically to configuration of a communications port.

### BACKGROUND

To configure network elements in a broadband access network, local network management systems may be used which are assigned to the individual network elements, such as an access multiplexer or access server (AN: access node), an IP-based gateway (BRAS: broadband remote access server), a customer authentication server (AAA: authentication, authorization, accounting), a customer profile server (KD server) or a DSL profile server. The configuration data of a broadband line is related to a physical port and configured statically. If a user changes a port, for example by relocating, the port configuration may be changed only by manually changing the configuration of the network elements affected. For example, CPE-relevant configurations (CPE: customer premise equipment) via existing physical DSL connections may be carried out (DSL: digital subscriber line). However, a DSL-specific configuration may not currently be carried out, as described, for example, in the DSL Forum, Document TR-69.

Standardization with regard to exchanging configuration or control data between a BRAS and an AN is currently under discussion in the DSL Forum. The documents WT-147 Layer 2 Control Mechanism (Framework) and IETF ANCP Protocol Specification (ANCP: Access Node Control Protocol) should also be mentioned in this connection. These documents provide a general description of a use case line configuration. However, no architecture concepts are described which are connected to the associated servers, AAA architectures and associated parameter exchange.

### SUMMARY

In an embodiment, the present invention provides a method for user-specific configuration of a communications port. The method includes provisioning a default profile that references a predetermined user, assigning the default profile to a user-specific configuration profile that is assigned to the predetermined user, and configuring the communications port using the user-specific configuration profile.

### BRIEF DESCRIPTION OF THE DRAWINGS

Further exemplary embodiments are explained in greater detail on the basis of the attached figures, in which:

FIG. 1 shows a block diagram of a network architecture; and

FIG. 2 shows a block diagram of a network entity.

### DETAILED DESCRIPTION

An embodiment of the invention provides an efficient concept of a line configuration.

An embodiment of the invention relates to a method for the user-specific configuration of a communications port, a default profile which references a predetermined user first being provided. The default profile is then assigned to a user-specific configuration profile, which is assigned to a predetermined user. The communications port is subsequently configured using the user-specific configuration profile.

An embodiment of the invention is based on the knowledge that communication is usually handled via communications ports. For example, an AN may manage a plurality of, for example, 1,000 communications ports and therefore subscriber lines, which are each assigned, for example, to a different user. In the concept according to an embodiment of the invention, a two-stage connection setup is provided, in which the default profile, which may include a basic configuration, is used in a first step to set up a basic connection, for example, to a BRAS. Based on the default profile, the user-specific connection parameters are then ascertained and transmitted in the form of the user-specific configuration profile to the AN managing the communications port affected.

According to a further embodiment, the default profile is transmitted to a first network entity, for example a BRAS, via a communications network, for example an IP-based communications network (IP: Internet Protocol). The first network entity assigns the default profile to the user-specific configuration profile, which is transmitted by the first network entity to a second network entity, for example an AN which manages the communications port, via the communications network. The second network entity receives the user-specific configuration profile and configures the communications port. Due to this decentralized management of the user-specific configuration profiles, each port is thus configurable on a user-specific basis independently of location.

The step of assigning the default profile to the user-specific configuration profile may include, for example the authentication or identification or detection of the location of the predefined user on the basis of the default profile. For this purpose, the default profile may include, for example, a layer 1 parameter or a layer 2 parameter of a communications protocol, for example an OSI communications protocol (OSI: Open System Interconnection). The layer 1 or layer 2 parameter may be, for example, a DSL layer parameter or an Ethernet parameter. In addition, the default profile may include an E-side electrical length (ESEL) parameter. The default profile may also include a user identification.

The step of user-specific configuration of the communications port may include, for example, a VLAN configuration (VLAN: virtual local area network) and/or a voice/data rerouting and/or a QoS setting (QoS: quality of service) and/or a CoS setting (CoS: class of service) and/or a packet filter setting and/or a frame filter setting and/or a multicast mode setting and/or a network access setting and/or a selection of a network-specific adaptation mechanism, for example an ATM mechanism (ATM: Asynchronous Transfer Mode) and/[or] an EFM (EFM: Ethernet in the First Mile), and/or a selection of an encapsulation type, in particular a bridge or a routing type.

A further embodiment of the invention relates to a network entity, for example a BRAS, for providing a user-specific configuration profile of a communications port, including a profile server for assigning a default profile to a further network entity, for example to an AN and/or to a user to obtain a basic configuration profile which is assigned to the further network entity and/or the user. The network entity further includes an application server for linking the basic configuration profile with user-specific data to obtain the user-specific configuration profile of the communications port.

The network entity may further include an authentication server or an identification server which is designed to authenticate or identify the further network entity or the user on the basis of the default profile.

The network entity may also include a receiver for receiving the default profile via a communications network and/or a transmitter for transmitting the user-specific configuration profile via the communications network.

A further embodiment of the invention relates to a method for providing a user-specific configuration profile of a communications port, in which a default profile is assigned to a further network entity or a user to obtain a basic configuration profile that is assigned to the further network entity or the user, and in which the basic configuration profile is linked with user-specific data to obtain the user-specific configuration profile of the communications port.

Further steps of the method for providing the user-specific configuration profile are derived from the functionality of the network entity according to an embodiment of the invention for providing the user-specific configuration profile.

A further embodiment of the invention relates to a network entity having a configurable communications port and a provision device, for example a memory, for providing a default profile, and a configuration device for configuring the configurable communications port, using the default profile, to obtain a default configuration of the configurable communications port. The network entity further includes a transmitter for transmitting the default profile using the default configuration, a receiver for receiving a user-specific configuration profile using the default configuration, the configuration device being designed to configure the configurable communications port using the user-specific configuration profile. The network entity may be, for example, an AN server which manages the configurable communications port.

A further embodiment of the invention relates to a method for configuring a configurable communications port by providing a default profile, configuring the configurable communications port using the default profile to obtain a default configuration of the configurable communications port, transmitting the default profile using the default configuration, receiving a user-specific configuration profile using the default configuration and configuring the configurable communications port using the user-specific configuration profile.

Further steps of the method for configuring the configurable communications port are derived directly from the functionality of the network entity according to an embodiment of the invention having the configurable communications port.

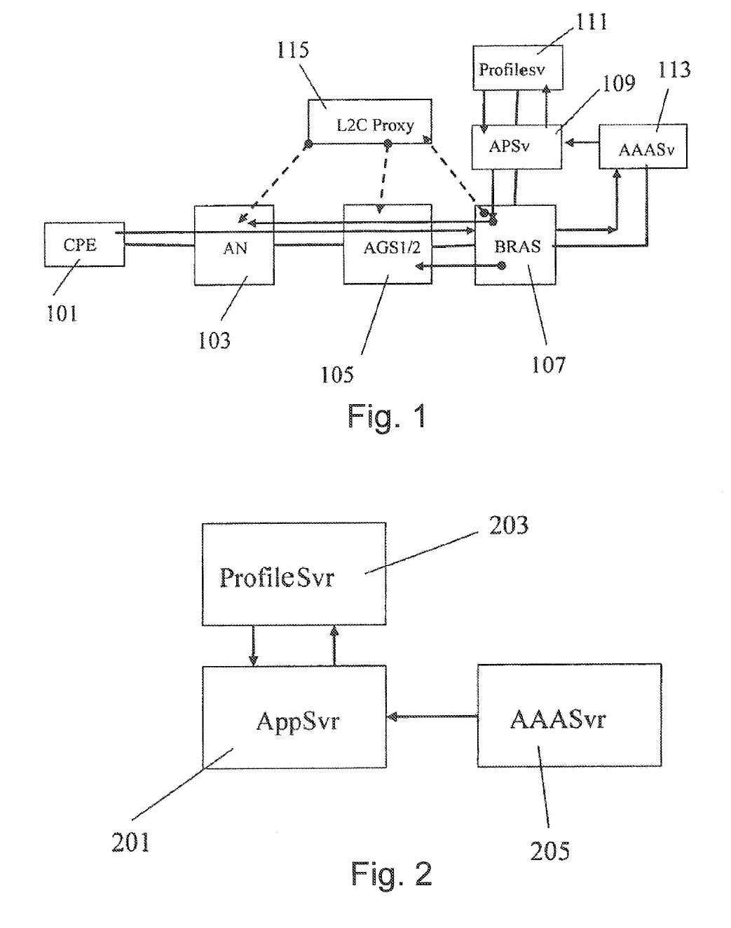

FIG. 1 shows a network architecture having a CPE 101, for example a personal computer, an access server 103, for example an AN, an optional application gateway server 105 (AGS 1/2), a BRAS 107, an application server 109, for example an application server (APSv), a profile server 111 and an authentication server 113 (AAASv). An optional L2C proxy 115 (L2C: second level cache) is also provided.

CPE 101 communicates with AN 103 as well as with BRAS 107 via optional AGS 105. In this case, AN 103 and BRAS 107 are network entities, it being possible for BRAS 107, application server 109, profile server 111 and authentication server 113 to form one network entity.

BRAS 107 communicates with AGS 105 and with servers 109, 111 and 113. AGS 105 is situated between AN 103 and BRAS 107, both AN 103 and AGS 105 as well as BRAS 107 communicating with L2C proxy 115.

Authentication server 113 also communicates, for example, with application server 109, which communicates with both profile server 111 and with BRAS 107.

One feature of the network concept according to an embodiment of the invention is the linking of a profile to be used to a user and not necessarily to a port. This enables the network operator to use existing central customer databases such as RADIUS (RADIUS: Remote Authentication Dial-In-User Service) for controlling the customer-specific and product-specific port configurations. For this purpose, a port or a line is configured from BRAS 107, for example as a function of a customer authentication (user authentication) and a user profile (customer profile). For this purpose the presence of a control line between BRAS 107 and AN 103, for example by means of ANCP (ANCP: Access Node Control Protocol), is advantageous. If a control line of this type does not exist, such a control line is added as needed to the architecture illustrated in FIG. 1. It is thus possible for a user to select the profile or functions that best fit(s) his applications, for example voice over IP. It is therefore possible, for example, to change, upgrade or downgrade a communications product such as voice over IP without requiring manual intervention on the part of a network operator.

The concept according to an embodiment of the invention is explained below by way of example on the basis of the DSL technology. However, the DSL technology is one of the many communications technologies in which the concept according to an embodiment of the invention may be used.

According to an embodiment of the invention, for example, a DSL line may be configured with a default profile that enables the user to access BRAS 107. BRAS 107 authenticates the users, for example using the RADIUS method. Following authentication or following identification of the user, the relevant product and a port profile may be called up on the basis of centrally stored data for the purpose of configuring the port.

This concept, which is referred to below as “zero touch”, makes it possible to save operating costs (OPEX: operational expenditure) because all lines are configurable using a minimum default profile, the user himself being able to initiate the configuration suitable for the product, for example the configuration for the voice over IP method.

As far as network dimensioning or network interconnection is concerned, the DSL lines may be operated, for example, in fixed rate mode or rate adaptive mode. In rate adaptive mode, the line—i.e., the connection—adapts to the physical conditions, for example physical transmission conditions such as attenuation, during synchronization. In this case, for example, a window may be specified, the synchronization taking place, for example, within the maximum values occurring within the window. However, this concept is difficult to implement in terms of network technology in a 100% network interconnection using DSL lines, which must be operated at a maximum bit rate. However, assuming that the DSL technology will be replaced in the future in connection with VoIP POTS (Voice over IP Plain Old Telephone Service) and ISDN, a 100% network interconnection must also be assumed. The lines therefore should not be configured to maximum values. The above concept therefore enables the AN or the port situated therein to be configured automatically and depending on the customer profile even in a 100% network interconnection.

As a function of the relevant product concept, for example a voice over IP concept or a quality of service concept, the DSL lines may be configured using a minimum default profile and the connection parameters may also be changed in connection with the seamless rate adaptation method, which may also be used for DSL, without interrupting the connection and having to operate the line at the maximum limits.

The aforementioned zero touch approach makes it possible to configure the connection parameters automatically, each DSL port being first started, for example, using a basic configuration according to a basic profile and the corresponding ESEL parameter. The ESEL parameters are derived, for example, from the location of the relevant AN (AN ID: AN identification). The ESEL configuration parameter defines the electrical length or attenuation of a main cable segment between an exchange and a distribution box (KVz) having a DSL feed. This information may be used, for example, to cause the transmission power to be adapted, for example with the aid of the downstream power back-off method (DPBO), by means of a central network unit such as DSLAM (DSLAM: Digital Subscriber Line Access Multiplexer).

The attenuation is indicated in decibels at a reference frequency of 1 MHz. The value range moves between 0 dB and 127.5 dB in increments of 0.5 dB. A value of 0 causes the DPBO method to be turned off. The transmission power must always be adapted if a transmitter feeds data signals at multiple locations, which is the case, for example, when a DSLAM is built into a distribution box, thereby supplying additional subscriber lines from the exchange via the same cable route.

In the aforementioned basic configuration according to the basic profile, it is now possible for a user to communicate with AAA server 113 via BRAS 107 to authenticate himself, for example. Upon successful authentication, the product used by this user is derived from the user data. The corresponding profile is transmitted, for example, to AN 103. The connection between the customer information (user information) and the port information may be established, for example, via vMAC (vMAC: virtual medium access control).

In a further embodiment of the zero touch approach, in which the CPE is integrated, entire product changes, including an automatic configuration of what may be permanently assigned IP addresses, VLANs, etc., may be accessible to a user-specific configuration. For example, particular user groups that use, for example, Business Voice Office or Business Access IP, may be integrated into an intranet or VPN (VPN: virtual private network) regardless of the login ID used. If the login ID is changed, the user concerned leaves the VPN and appears as a private user on the Internet.

The authentication first takes place, for example, with the aid of a basic profile. The profile, which must be assigned to the relevant port, is provided by profile server 111 in the form of a basic profile. This profile, which is currently used to parameterize the line, may now contain additional details on configuring the CPE, for example to add this line to a VPN. This concept may be implemented, for example, in a PABX in the network, which is currently implemented on an MSP (multi-service platform).

At the same time, BRAS 107 sends the configuration to CPE 101 via the existing connection between BRAS 107 and CPE 101, for example a PPPoE connection (Point to Point Protocol over Ethernet) or a DHCP connection (DHCP: Dynamic Host Configuration Protocol), insofar as such a configuration of CPE 101 arises from the required product or is necessary therefor. CPE 101 changes its configuration according to the transferred data, it being possible to resynchronize the DSL connection. According to a further embodiment, both VN 103 and AGS 105 may be included in the procedures described above (VLAN interconnection). In addition to the configuration of the transmission aspects, settings may also be made on OSI layers 2 through 4. In this case, it is possible to configure the VLAN, reroute voice traffic, add or change the CoS/QoS, set packet filters or frame filters, control the multicast products or access lists, select the particular adaptation mechanism (such as ATM or EFM) or select the encapsulation type, such as bridge or routing mode.

The concept according to an embodiment of the invention thus supports extensive port mobility, in particular DSL port mobility, it being possible for a user to connect via any DSL port on the basis of a default profile and obtain his associated product profile on the basis of the customer identification, within the physical limits of the particular line.

According to an embodiment of the invention, the default profile may include all technical parameters needed to configure a port, for example a DSL port. The default profile is understood to be a basic profile which makes it possible to configure the DSL port for data transmission by assigning a minimum parameter set. The transferred parameters are preferably not complete, but they support an emergency operation which permits rudimentary communication. For example, layer 1 parameters may be transferred as the content, for example DSL layer parameters such as DSL type, or electrical parameters. Layer 2 parameters may also be transferred, for example Ethernet parameters such as VLAN, filter functions or CoS. By transferring the parameter set or the profile, the configuration of a port is assigned to that particular port. The parameter set may include, for example, the layer 1 and layer 2 parameters.

FIG. 2 shows a network entity comprising an application server 201 (AppSvr), a profile server 203 and an authentication server 205 (AAASvr). Application server 201 communicates with profile server 203 as well as with authentication server 205 in the manner illustrated in FIG. 2. In this case, a correlation of the different users or port information is carried out between profile server 203, application server 201 and authentication server 205.

Profile server 203 is provided, for example, to detect an AN and its location, for example on the basis of the AN ID and the vMAC. The BRAS detects the AN, for example, on the basis of the AN ID and the ANCP-PORTUP message (ANCP: Access Node Control Protocol).

Any PPPoE intermediate agent that may be used may also insert the origin code, for example into the PPPoE packet (AN ID, slot, port), so that the BRAS may correlate the incoming ANCP messages with the end product of the PPPoE connection. Alternatively, the BRAS may also use the vMAC as the basis. The vMAC is formed, for example, according to a defined algorithm, it being possible to make an assignment to the ANCP messages.

Profile server 203 also ascertains the ESEL parameters described above, which are specific to each AN. They depend on different factors and are ascertained during project planning of an AN location and stored in a database. These parameters are valid AN-wide and as a rule do not change any further throughout the entire time the AN is in operation.

Profile server 203 may also be provided to transfer the profile to application server 201. The profile data may be transferred to application server 201, for example on request.

Application server 201 is provided, for example, to combine the particular application with the profile and the customer data. The profile provided by profile server 203 and including the AN-specific data may be combined, for example with the user-specific data. This results in the profile to be used for the AN. Application server 201 receives the user-specific portions for the profile from authentication server 205. During the course of authentication (for example via PPPoE), authentication server 205 returns the profile belonging to the transferred user data. Application server 201 does not itself perform any authentication. This task is handled by authentication server 205. However, application server 201 transmits the login data to authentication server 205 and evaluates the authentication result.

Furthermore, application server 201 may send a request to change the profile. After the profile to be used has been formed, the BRAS may, for example, request the AN to change a profile. This request may be made, for example, via ANCP. This function may be implemented as discussed below.

According to one embodiment, the profile data record may be transferred in full (complete push). A profile which may be assigned to the particular port is derived from the product information as well as from the location information (e.g. AN ID, vMAC) via a profile server. For example, this profile may be retransferred to the AN via ANCP and assigned therein via ANCP. Assigning this profile changes the synchronization state of the line with or without resynchronization, it being possible to carry out a seamless rate adaptation.

According to a further embodiment, parts of the profile data record may be transferred from the BRAS (partial push mode). In this case, the profile may be generated directly on the AN, provided that this AN supports this function. The AN-specific parameters are already configured on the AN, for example as the ESEL parameters. The customer-specific or product-specific parameters may be transmitted to the AN, which may add them to a profile for the particular user port. Assigning this profile changes the synchronization state of the line with or without resynchronization, it being possible to carry out a seamless rate adaptation.

According to a further embodiment, the AN may retrieve the profile data record from profile server 203 (pull mode). In this case, a reference, for example a profile name, is transferred to the AN. The AN retrieves the profile from profile server 203. Assigning this profile changes the synchronization state of the line with or without resynchronization, it being possible to carry out a seamless rate adaptation.

According to a further embodiment, a time-based control many be carried out if requested by a temporary application. If, for example, the profile should be temporarily changed, the product profile reverts to the initial state after a predetermined period of time. The trigger for the change may be timer-controlled or carried out by an external control signal.

According to a further embodiment, the AN may remain in the initial configuration if it is not possible to set the desired profile from the AN (fallback mode). This is followed, for example, by a reply from the AN to the application server.

Authentication server 205 is provided, for example, to detect or identify the user. In this case, the user may be detected by means of PPPoE dial-in at authentication server 205, for example using the prefix of the customer identification. The product profile posted by the user is ascertainable on the basis of the authentication, and the configuration may be initiated as described above. The tasks of authentication server 205 include, for example, reconciling the customer data with the port information or providing or administering accounting information.

According to an embodiment of the invention, an attempt is made to link the connection profile to the user. However, the AN always changes the connection configuration, for example, to another profile determined by the user only from the default profile. In order for another user, for example, to log into the same port at the same time, for example to the same DSL port, the DSLAN, for example, should not perform any further profile changes. As long as no user is logged in, the default profile is valid on the connecting line or for the port. For example, this profile enables a modem or an IAD or a router to synchronize with the AN at a lower bandwidth, or it permits IP communication with a BRAS.

While the invention has been particularly shown and described with reference to preferred embodiments thereof, it will be understood by those skilled in the art that various changes in form and details may be made therein without departing from the spirit and scope of the invention.

1-13. (canceled)

14. A method for the user-specific configuration of a communications port, the method comprising:
provisioning a default profile that references a predetermined user;
assigning the default profile to a user-specific configuration profile that is assigned to the predetermined user; and
configuring the communications port using the user-specific configuration profile.

15. The method according to claim 14, further comprising:
transmitting the default profile to a first network entity via a communications network;
assigning, by the first network entity, the default profile to the user-specific configuration profile;
transmitting the user-specific configuration profile by the first network entity to a second network entity via the communications network;
receiving the user specific configuration profile by the second network entity; and
configuring the communications port by the second network entity.

16. The method according to claim 14, wherein the assigning the default profile comprises at least one of:
authenticating the predetermined user based on the default profile;
identifying the predetermined user based on the default profile; and
detecting a location of the predetermined user based on the default profile.

17. The method according to claim 15, wherein the assigning the default profile comprises at least one of:
authenticating the second network entity based on the default profile;
identifying the second network entity based on the default profile; and
detecting a location of the second network entity based on the default profile.

18. The method according to claim 14, wherein the default profile includes at least one of a layer 1 and a layer 2 parameter of a communications protocol.

19. The method according to claim 18, wherein the parameter of a communications protocol is a digital subscriber line (DSL) layer parameter.

20. The method according to claim 18, wherein the parameter of a communications protocol is an Ethernet parameter.

21. The method according to claim 14, wherein the default profile includes an E-side electrical length parameter.

22. The method according to claim 14, wherein the default profile includes a user identification.

23. The method according to claim 14, wherein the configuring the communications port using the user-specific configuration profile comprises at least one of:
configuring a virtual local area network;
rerouting voice traffic;
rerouting data traffic;
configuring a quality of service setting;
configuring a class of service setting;
configuring a packet filter setting;
configuring a frame filter setting;
configuring a multicast mode setting;
configuring a network access setting;
selecting a network-specific adaptation mechanism; and
selecting an encapsulation type.

24. The method according to claim 14, wherein the configuring the communications port using the user-specific configuration profile comprises selecting a network-specific adaptation mechanism and wherein the network-specific adaptation mechanism includes at least one of asynchronous transfer mode (ATM) and Ethernet in the first mile (EFM).

25. The method according to claim 14, wherein the configuring the communications port using the user-specific configuration profile comprises selecting an encapsulation type and wherein the encapsulation type is one of a bridge and a routing type.

26. A network entity for providing a user-specific configuration profile of a communications port, the network entity comprising:
a profile server operative to assign a default profile to a further network entity so as to obtain a basic configuration profile that is assigned to the further network entity; and
an application server operative to link the basic configuration profile with user specific data to obtain a user-specific configuration profile of the communications port.

27. The network entity according to claim 26, further comprising an authentication server operative to authenticate at least one of the further network entity and a user based on the default profile.

28. The network entity according to claim 26, further comprising an identification server operative to identify at least one of the further network entity and a user based on the default profile.

29. The network entity according to claim 26, further comprising a receiver operative to receive the default profile.

30. The network entity according to claim 26, further comprising a transmitter operative to transmit the user-specific configuration profile.

31. A method for providing a user-specific configuration profile of a communications port, the method comprising:
assigning a default profile to a further network entity so as to obtain a basic configuration profile that is assigned to the further network entity; and
linking the basic configuration profile with user-specific data to obtain the user-specific configuration profile of the communications port.

32. A network entity comprising:
a configurable communications port;
a provisioning device operative to provide a default profile;
a configuration device operative to configure the configurable communications port using the default profile so as to obtain a default configuration of the configurable communications port;
a transmitter operative to transmit the default profile using the default configuration; and
a receiver operative to receive a user-specific configuration profile using the default configuration,
wherein the configuration device is further operative to configure the configurable communications port using the user-specific configuration profile.

33. A method for configuring a configurable communications port, the method comprising:
provisioning a default profile;
configuring the configurable communications port using the default profile so as to obtain a default configuration of the configurable communications port;
transmitting the default profile using the default configuration;
receiving a user-specific configuration profile using the default configuration; and
configuring the configurable communications port using the user-specific configuration profile.
